(19) United States
(12) Patent Application Publication
(10) Pub. No.: US 2015/0024709 A1
(43) Pub. Date: Jan. 22, 2015

(54) METHOD AND SERVER FOR SHARING DATA TRAFFIC

(71) Applicants: Fu Tai Hua Industry (Shenzhen) Co., Ltd., Shenzhen (CN); HON HAI PRECISION INDUSTRY CO., LTD., New Taipei (TW)

(72) Inventors: JIANG-TAO SHAN, Shenzhen (CN); CHIH-SAN CHIANG, New Taipei (TW); YUN ZHAO, Shenzhen (CN); HUA-DONG CHENG, Shenzhen (CN)

(21) Appl. No.: 14/330,410

(22) Filed: Jul. 14, 2014

(30) Foreign Application Priority Data
Jul. 19, 2013 (CN) 2013103048489

(51) Int. Cl. H04M 15/00; H04W 28/02

(52) U.S. Cl. CPC H04M 15/887; H04W 28/0215; H04M 15/721; H04M 15/723
USPC 455/407; 455/418; 455/408

(57) ABSTRACT

A method for permitting a first communication device to share data traffic with a second communication device is provided, where at least the user of the second device subscribes to a data traffic plan. The server of telecommunications network determines whether the authorization code and an identity information of the first communication device sent by the first communication device matches the authorization code and a related identity information stored in the server; if so, the data quantity sent to or from the first communication device is counted for billing to the second communication device.

### FIELD

The present disclosure relates to communication technologies, specifically to a server and method for permitting one or more clients to borrow or share data traffic with each other.

### BACKGROUND

One possibility of using mobile telecommunications services (i.e. services based on the use of mobile telecommunications networks to supply mobile radio units) is the use of a so-called data traffic plan. In some plans, the user or subscriber has a maximum data volume, for example 1 GB per time interval, typically a one month interval. The subscriber is required to pay high per-megabyte overusage charges, if subscriber exceeds the maximum data volume in the time interval.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a first communication device and a second communication device connected on a mobile telecommunications network, according to an exemplary embodiment.

FIG. 2 is a block diagram of a controlling system for sharing wireless data traffic, according to an exemplary embodiment.

FIG. 3 is a block diagram showing the communication system of FIG. 2 executed on the first communication device and the second communication device of FIG. 1.

FIG. 4 is a flow chart of a method for permitting one or more clients to borrow or share data traffic with each other, according to an exemplary embodiment.

### DETAILED DESCRIPTION

The disclosure, including the accompanying, is illustrated by way of example and not by way of limitation. It should be noted that references to “an” or “one” embodiment in this disclosure are not necessarily to the same embodiment, and such references mean “at least one.”

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other storage medium.

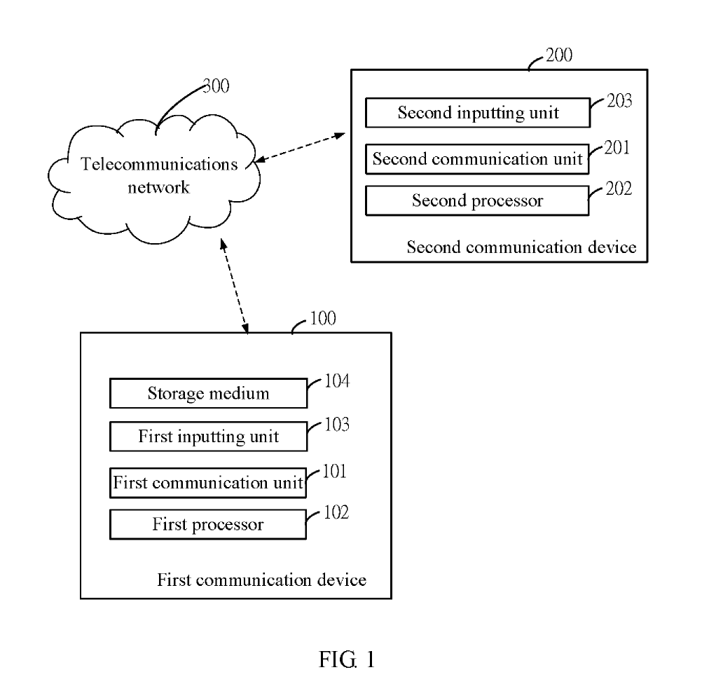

Referring to FIG. 1, a first communication device 100 and a second communication device 200 are connected on a telecommunications network 300. The subscribers of the first communication device 100 and the second communication device 200 obtain telecommunications services based on the use of the telecommunications network 300, for example, a service for interactive data from the Internet. The telecommunications network 300 can be a 3rd Generation Telecommunications Network, a 4th Generation Telecommunications Network, a General Packet Radio Services (GPRS) network, a Global System for Mobile (GSM) communications network, an Enhanced Data Rate for GSM Evolution (EDGE) network, or the like.

Generally, the telecommunications network 300 includes a Serving GPRS Support Node (SGSN), a Gateway GPRS Support Node, (GGSN), a Mobile Switching Center (MSC), and a Pocket Switched Domain.

In this embodiment, the first communication device 100 and the second communication device 200 are cellular telephones. In other embodiments, the first communication device 100 and the second communication device 200 can be smart phones, PDAs (personal digital assistants), personal navigation devices, or the like.

The first communication device 100 includes a first communication unit 101, a first processor 102, a first inputting unit 103, and a storage medium 104, the first communication device 100 registers and connects to the telecommunications network 300 via the first communication unit 101. Similarly, the second communication device 200 includes a second communication unit 201, a second processor 202, and a second inputting unit 203, the second communication device 200 registers and connects to the telecommunications network 300 via the second communication unit 201.

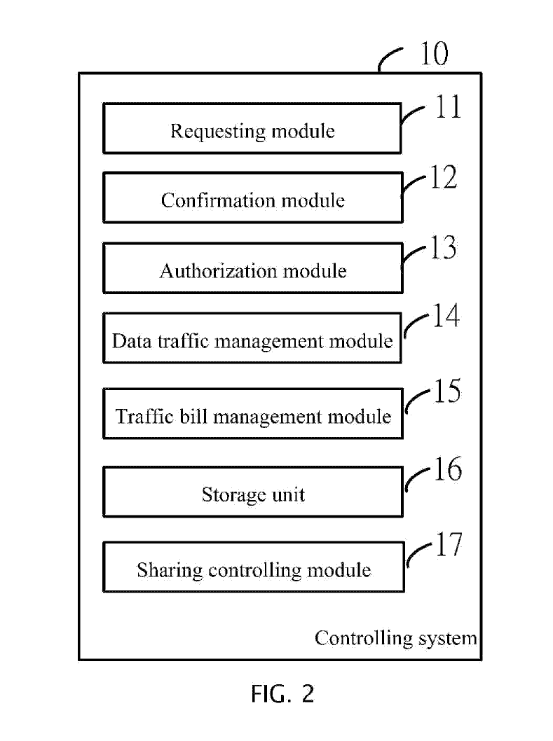

Referring to FIG. 2, a controlling system 10 for sharing wireless data traffic includes a requesting module 11, a confirmation module 12, an authorization module 13, a data traffic management module 14, a traffic bill management module 15, a storage unit 16, and a sharing controlling module 17.

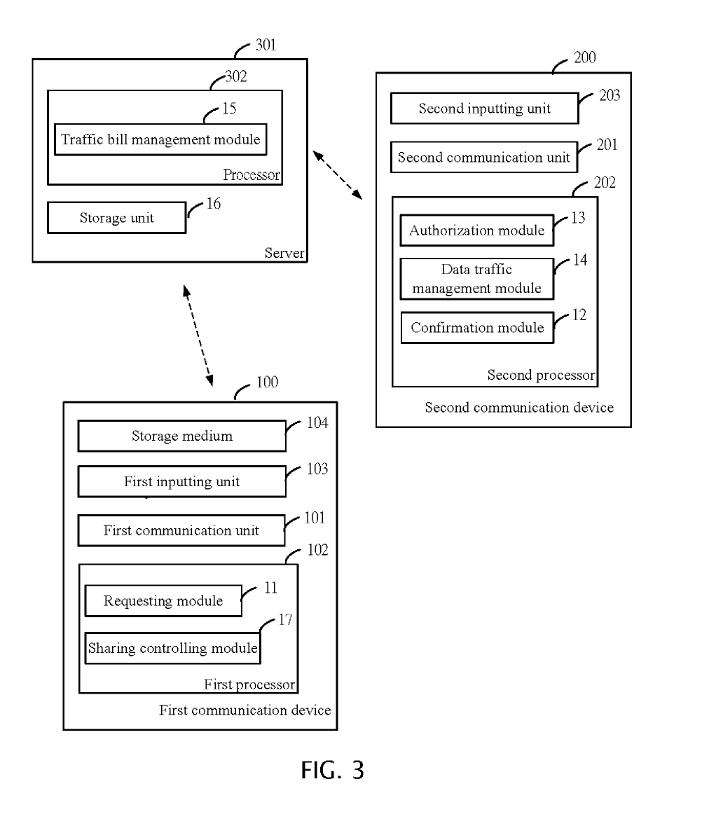

Referring to FIG. 3, the controlling system 10 is executed on the first communication device 100, the second communication device 200, and a server 301 of telecommunications network 300. The requesting module 11 and the sharing controlling module 17 are executed on the first processor 102 of the first communication device 100. The confirmation module 12, the authorization module 13, and the data traffic management module 14 are executed on the second processor 202 of the second communication device 200. The traffic bill management module 15 is executed on a processor 302 of the server 301 of telecommunications network 300. The traffic bill management module 15 counts the quantity of data that the service provider receives from or passes to the first communication device 100 or the second communication device 200, and calculates a fee to the subscriber.

An example of the first communication device 100 requesting to borrow data traffic of the second communication device 200 is disclosed below.

The requesting module 11 generates a sharing request signal in response to user's selection on the first inputting unit 103 of the first communication device 100, the first communication unit 101 transfers the sharing request signal to the second communication device 200. The sharing request signal includes identity information of the first communication device 100, the identity information can be card number of a Subscriber Identity Module Card (SIM) of the first communication device 100 or a secret number or code inputted by the user of the first communication device 100.

The second communication unit 201 of the second communication device 200 receives the sharing request signal from the telecommunications network 300.

The confirmation module 12 generates a confirmation command if the user of the second communication device 200 selects to share the data traffic with the first communication device 100. In detail, the second communication device 200 provides a selecting message to a user of the second communication device 200 to choose whether or not to allow the first communication device 100 to share the data traffic of the second communication device 200, in response to the sharing request signal. If yes, the confirmation module 12 generates the confirmation command.

The authorization module 13 generates an authorization code in response to the confirmation command. The authorization code corresponds to the identity information of the first communication device 100. The second communication unit 201 transfers the authorization code to the first communication device 100, and transfers the authorization code and the related identity information which is contained in the received sharing request signal to the server 301 of telecommunications network 300.

The storage unit 16 of the server 301 of telecommunications network 300 stores the received authorization code and the received identity information. The first communication device 100 also includes a storage medium 104 to store the authorization code transferred by the second communication device 200.

When the first communication device 100 desires to use mobile telecommunications service by sharing the data traffic of the second communication device 200, the sharing controlling module 17 obtains the authorization code from the storage medium 104 and transfers the authorization code and the identity information of the first communication device 100 to the server 301 of telecommunications network 300. In detail, the sharing controlling module 17 determines whether an authorization code is stored in the storage medium 104 of the first communication device 100, and transfers the authorization code and the identity information of the first communication device 100 to the server 301 of telecommunications network 300 when at least one authorization code is stored in the storage medium 104.

The traffic bill management module 15 of the sever 301 determines whether the received authorization code and identity information of the first communication device 100 are matches of the authorization code and the related identity information stored in the storage unit 16. The traffic bill management module 15 counts the quantity of data that the service provider receives from or passes to the first communication device 100 in a bill of the second communication device 200, when the traffic bill management module 15 determines that the received authorization code and identity information of the first communication device 100 do match the authorization code and the related identity information stored in the storage unit 16.

The data traffic management module 14 counts the data traffic of the second communication device 200. In an embodiment, the data traffic management module 14 requests the server 301 of telecommunications network 300 to return currently used data traffic quantity and remaining data traffic quantity of the second communication device 200. The data traffic management module 14 further determines whether currently used data traffic of the second communication device 200 exceeds a maximum data volume of the data traffic plan subscribed to by user of the second communication device 200, and generates an end signal when the currently used data traffic of the second communication device 200 equals the maximum data volume.

The authorization module 13 generates an empty command in response to the end signal and the second communication unit 201 transfers the authorization code to the server 301 of telecommunications network 300. The traffic bill management module 15 of the server 301 vacates the authorization code and the related identity information stored in the storage unit 16 in response to the vacate command. Therefore, the traffic bill management module 15 ceases to be able to match the authorization code and identity information sent by the first communication device 10, thus stopping the first communication device 10 from sharing the data traffic of the second communication device 200.

With such configuration, users of the communication device can allow other devices to share an unused portion of their quota of permitted data traffic of a subscription data traffic plan.

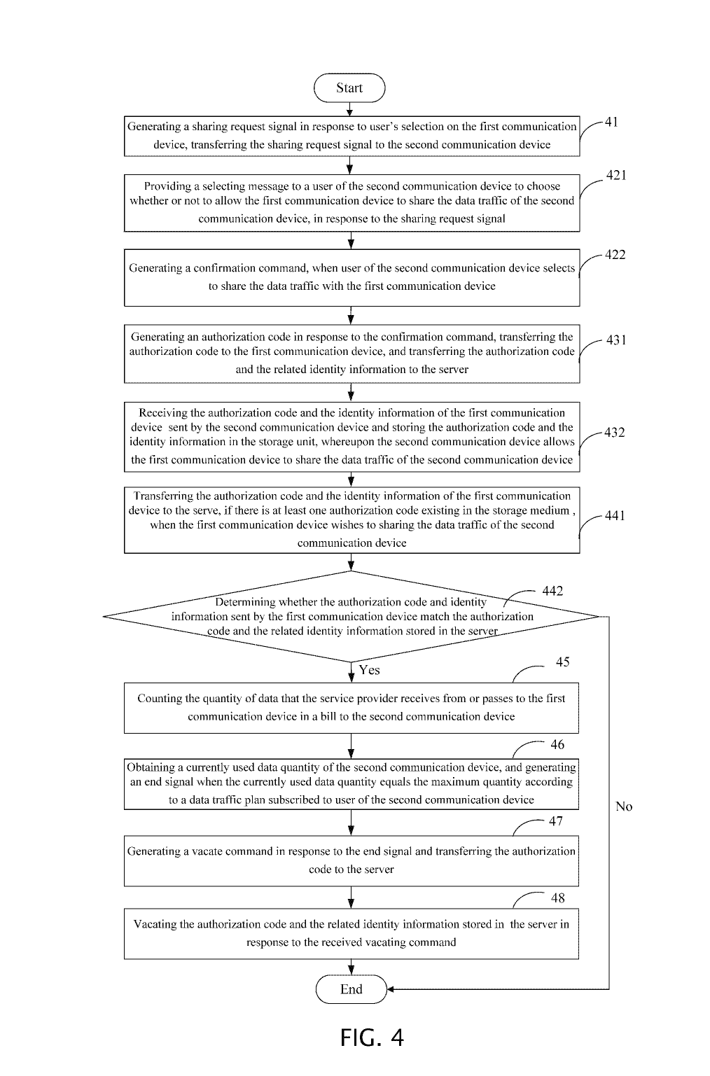

Referring to FIG. 4, a flowchart of a method for permitting one or more clients to borrow or share data traffic with each other is hereafter described.

In block 41, generating a sharing request signal in response to user's selection on the first inputting unit 103 of the first communication device 100, and transferring the sharing request signal to the second communication device 200. The sharing request signal includes identity information of the first communication device 100.

In block 421, providing a selecting message to a user of the second communication device 200 to choose whether or not to allow the first communication device 100 to share the data traffic of the second communication device 200, in response to the sharing request signal.

In block 422, generating a confirmation command, when user of the second communication device 200 does select sharing data traffic with the first communication device 100.

In block 431, generating an authorization code in response to the confirmation command, transferring the authorization code to the first communication device 100, and transferring the authorization code and the related identity information which is contained in the received sharing request signal to the server 301 of telecommunications network 300.

In block 432, receiving and storing the authorization code and the identity information of the first communication device 100 sent by the second communication device and storing the authorization code and the identity information in the storage unit 16, whereupon the second communication device allows the first communication device to share the data traffic of the second communication device.

In block 441, transferring the authorization code and the identity information of the first communication device 100 to the server 301 of telecommunications network 300, if there is at least one authorization code existing in the storage medium 104, when the first communication device 100 desires to use mobile telecommunications service by sharing the data traffic of the second communication device 200. In detail, when the first communication device 100 wishes to share data traffic of the second communication device 200, the sharing controlling module 17 determines whether there is at least one authorization code existing in the storage medium 104, if yes, the sharing controlling module 17 obtains the authorization code from the storage medium 104 and transfers the authorization code and the identity information of the first communication device 100 to the server 301 of telecommunications network 300.

In block 442, determining whether the authorization code and identity information of the first communication device 100 sent by the first communication device 100 match the authorization code and the related identity information stored in the server 301 of telecommunications network 300, if yes, go to block 45; if not, ends.

In block 45, counting the quantity of data that the service provider receives from or passes to the first communication device 100 in a bill to the second communication device 200, when the traffic bill management module 15 determines that the received authorization code and identity information of the first communication device 100 do match the authorization code and the related identity information stored in the storage unit 16.

In block 46, obtaining a currently used data quantity of the second communication device 200, and generating an end signal when the currently used data quantity of the second communication device 200 equals the maximum quantity according to a data traffic plan subscribed to by user of the second communication device 200.

In block 47, generating a vacate command in response to the end signal and transferring the authorization code to the server 301 of telecommunications network 300.

In block 48, vacating the authorization code and the related identity information stored in the storage unit 16 in response to the received vacate command.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A method for a second communication device to share data traffic with a first communication device, the method comprising:
providing a selecting message to a user of the second communication device to choose whether or not to allow the first communication device to share the data traffic of the second communication device, in response to a sharing request signal sent by the first communication device, wherein the sharing request signal includes identity information of the first communication device;
generating a confirmation command, when the user of the second communication device selects to share the data traffic with the first communication device; and
generating an authorization code corresponding to the identity information of the first communication device in response to the confirmation command;
transferring the authorization code to the first communication device; and
transferring the authorization code and the corresponding identity information to a server of telecommunications network.

2. The method as described in claim 1, further comprising
obtaining a current used data traffic of the second communication device;
generating an end signal when the current used data traffic of the second communication device exceeds a maximum data volume of a data traffic plan subscribed by user of the second communication device; and
generating an empty command in response to the end signal and transferring the empty command to the server.

3. A method for a server of telecommunications network to permit a first communication device to share data traffic with a second communication device, the method comprising:
receiving an authorization code and an corresponding identity information of the first communication device sent by the second communication device and storing the authorization code and the corresponding identity information in the server, when the second communication device allows the first communication device to share the data traffic of the second communication device;
receiving an authorization code and an identity information of the first communication device sent by the first communication device, when the first communication device uses mobile telecommunications service by sharing the data traffic of the second communication device;
determining whether the authorization code and the identity information of the first communication device sent by the first communication device is a match with the authorization code and the corresponding identity information stored in the server; and
counting data traffic of the first communication device in a bill of the second communication device, when the received authorization code and identity information of the first communication device sent by the first communication device matches with the authorization code and the corresponding identity information stored in the server.

4. The method as described in claim 3, further comprising
empting the authorization code and the related identity information stored in the server in response of an empty command sent by the second communication device, when the current used data traffic of the second communication device exceeds a data traffic plan subscribed by user of the second communication device.

5. A server of telecommunications network to permit a first communication device to share data traffic with a second communication device comprising:
a processor; and
a plurality of storage unit storing a plurality of instructions, which when executed by the processor, causes the processor to:
receiving an authorization code and an corresponding identity information of the first communication device sent by the second communication device and storing the authorization code and the corresponding identity information in the server, when the second communication device allows the first communication device to share the data traffic of the second communication device;
receiving an authorization code and an identity information of the first communication device sent by the first communication device, when the first communication device uses mobile telecommunications service by sharing the data traffic of the second communication device;
determining whether the authorization code and the identity information of the first communication device sent by the first communication device is match to the authorization code and the corresponding identity information stored in the server;
counting data traffic of the first communication device in a bill of the second communication device, when the received authorization code and identity information of the first communication device sent by the first communication device matches to the authorization code and the corresponding identity information stored in the server.

6. The server as described in claim 5, wherein the processor further comprising
empting the authorization code and the related identity information stored in the server in response of an empty command sent by the second communication device, when the current used data traffic of the second communication device exceeds a data traffic plan subscribed by user of the second communication device.
